(19) United States
(12) Patent Application Publication
(10) Pub. No.: US 2006/0114369 A1
(43) Pub. Date: Jun. 1, 2006

(54) Liquid crystal display apparatus

(76) Inventors: Jeong-Hwan Lee, Gyeonggi-do (KR); Byung-Woong Han, Incheon (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/541,897

(22) PCT Filed: Feb. 12, 2004
(86) PCT No.: PCT/KR04/00278

§ 371 Date: Jul. 7, 2005

(30) Foreign Application Priority Data
Feb. 19, 2003 (KR) 10-2003-0010252

(51) Int. Cl. G02F 1/1335

(52) U.S. Cl. 349/61

(57) ABSTRACT

In a backlight assembly capable of increasing luminance and preventing the breakage of an L CD panel and an LCD apparatus having the backlight assembly, the backlight assembly includes a light generating part, a light controlling part and a light condensing part. The light generating part generates a light. The light controlling part controls the light generated from the light generating part. The light condensing part is integrally formed with the light controlling part so as to condense the controlled light. Therefore, the light condensing part is integrally formed with the light controlling part so as to increase luminance and to prevent the breakage of the LCD panel and the warping of the reflective polarizing film.

### TECHNICAL FIELD

The present invention relates to a backlight assembly and a liquid crystal display (LCD) apparatus having the backlight assembly. More particularly, the present invention relates to a backlight assembly capable of increasing luminance and endurance and an LCD apparatus having the backlight assembly.

### BACKGROUND ART

An information processing apparatus processes an image data. A display apparatus converts the image data into an optical image. Thus, a user may recognize the optical image. Recently, the display apparatus has been developed in accordance with a development of the information processing apparatus.

A flat panel display apparatus has various characteristics, for example, such as high luminance, high efficiency, uniform luminance, long lifetime, thin thickness, light weight and low cost and so on. The flap panel display apparatus is also capable of a full-color and high resolution display. The flat panel display apparatus has better display quality than a cathode-ray tube (CRT) display apparatus.

A liquid crystal display (LCD) apparatus, that is one of the flat display apparatuses, includes an LCD panel having a color filter substrate, a thin film transistor (TFT) substrate having electrodes thereon, and a liquid crystal layer interposed between the color filter substrate and the TFT substrate. In the LCD apparatus, an arrangement of liquid crystal molecules are adjusted in response to an electric field applied thereto, and thus a light transmittance thereof may be changed to display an image.

The LCD panel does not emit a light by itself, but the LCD panel receives an external light to display an image. Thus, the LCD panel requires a backlight assembly that provides the LCD panel with a light.

The conventional LCD apparatus includes an LCD panel 100 and a backlight assembly disposed under the LCD panel.

The backlight assembly includes a plurality of lamps generating a light, and a reflecting plate that is disposed under the lamps so as to reflect the light. A light diffusion plate is disposed on the lamps, and the light diffusion plate diffuses the light generated from the lamps so that the diffused light has a uniform luminance. A diffusion sheet is disposed on the light diffusion plate, and a brightness enhancement sheet is disposed on the diffusion sheet. A protection sheet is disposed on the brightness enhancement sheet, and a reflective polarizing film is disposed on the protection sheet. The diffused light passes through the diffusion sheet 118, the brightness enhancement sheet, the protection sheet and the reflective polarizing film so that the light is guided into the LCD panel.

The reflective polarizing film transforms the light supplied from the protection sheet to a polarized light so that the polarized light passes through the LCD panel.

The LCD panel includes polarizers through which a portion of the polarized light having a predetermined direction passes.

The polarizers having a thin film shape are disposed on and under the LCD panel. As a thickness of the LCD panel is decreased, the LCD panel may be fragile and unstable.

Also, the brightness enhancement sheet disposed under the reflective polarizing film may be folded and warped to cause a defect of the LCD apparatus.

### DISCLOSURE OF INVENTION

### TECHNICAL PROBLEM

The present invention provides a backlight assembly capable of increasing luminance and endurance.

The present invention also provides and LCD apparatus having the backlight assembly.

### TECHNICAL SOLUTION

The backlight assembly in accordance with one exemplary embodiment of the present invention includes a light generating part, a light controlling part and a light condensing part. The light generating part generates a light. The light controlling part controls the light generated from the light generating part. The light condensing part is integrally formed with the light controlling part so as to condense the controlled light.

The LCD apparatus in accordance with one feature of the present invention includes an LCD panel and a backlight assembly. The LCD panel includes an upper substrate and a lower substrate combined with the upper substrate to interpose a liquid crystal layer between the upper and lower substrates. The backlight assembly includes a lamp generating a light for the LCD panel, a light controlling part controlling the light generated from the lamp, and a light condensing part integrally formed on the light controlling part to condense the light.

The LCD apparatus in accordance with another feature of the present invention includes an LCD panel and a backlight assembly. The LCD panel includes an upper polarizer having a first polarizing axis, an upper substrate disposed under the upper polarizer, a lower substrate combined with the upper substrate so as to interpose a liquid crystal layer between the upper and lower substrates, a lower polarizer disposed under the lower substrate to have a second polarizing axis that is substantially perpendicular to the first polarizing axis, and a reflecting polarizing film integrally formed under the second polarizer.

The backlight assembly includes a lamp generating a light for the LCD panel, a light diffusion plate diffusing the light generated from the lamp, a brightness enhancement sheet integrally formed with the light diffusion plate so as to condense the diffused light, a protection sheet disposed on the brightness enhancement sheet so as to prevent the breakage of the LCD panel, and a reflecting plate disposed under the lamp so as to reflect the light generated from the lamp into the light diffusion plate.

Therefore, the light condensing part is integrally formed with the light controlling part so as to increase luminance and to prevent the breakage of the LCD panel and to prevent the warping of the reflective polarizing film.

### DESCRIPTION OF DRAWINGS

The above objects and other advantages of the present invention will become more apparent by describing in detail the preferred embodiments thereof with reference to the accompanying drawings, in which:

FIG. 1 is a cross-sectional view illustrating an LCD apparatus according to one exemplary embodiment of the present invention;

FIG. 2 is a graph illustrating a beam profile of a monitor having an edge-illumination type backlight assembly according to one exemplary embodiment of the present invention; and

FIG. 3 is a graph illustrating a beam profile of a television receiver set having a direct-illumination type backlight assembly according to one exemplary embodiment of the present invention.

### MODE FOR INVENTION

Hereinafter, the present invention will be explained in detail.

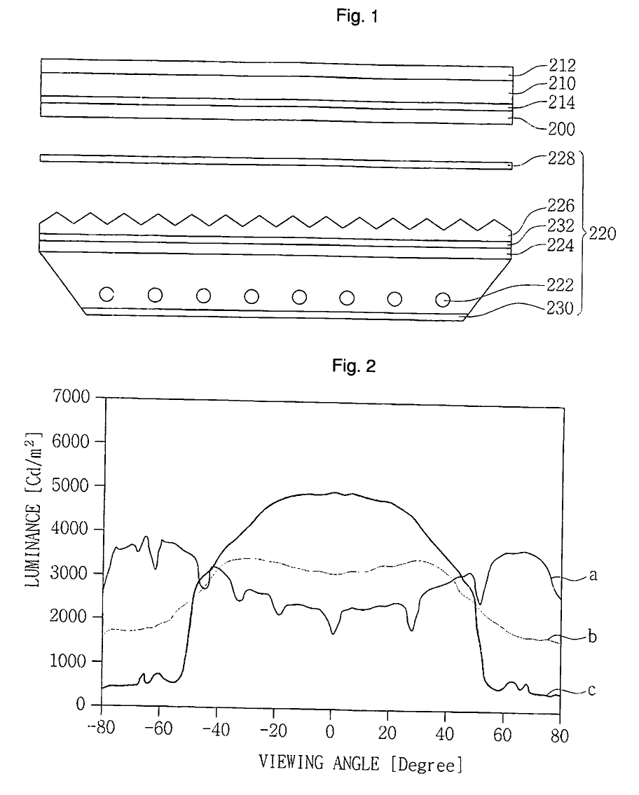

FIG. 1 is a cross-sectional view illustrating an LCD apparatus according to one exemplary embodiment of the present invention.

Referring to FIG. 1, the LCD apparatus includes an LCD panel 210 having a reflective polarizing film 200 disposed under the LCD panel 210, and a direct-illumination type backlight assembly 220.

The LCD panel 210 includes a first polarizer 212 disposed on the LCD panel 210, and a second plarizer 214 disposed under the LCD panel 210. The polarizing film 200 is attached on the second polarizer 214 by an adhesive, so that the polarizing film 200 and the second polarizer 214 are combined with each other. Integrally forming by the adhesive is referred to as Laminating′.

The second polarizer 214 disposed under the LCD panel 210 transmits a portion of a light generated from the direct-illumination type backlight assembly 220, which has the same polarizing axis as a polarizing axis of the second polarizer 214. The first polarizer 212 disposed on the LCD panel 210 transmits a portion of the light passing through the second polarizer 214 so that the light passing through the first polarizer 212 has a first polarization axis that is different from the second polarization axis of the second polarizer 214.

The reflective polarizing film 200 integrally formed with the second polarizer 214 transmits a portion of the light supplied from the second polarizer 214 into the second polarizer 214. A polarizing axis of the reflective polarizing film 200 is substantially the same as the second polarizing axis. The reflective polarizing film 200 may comprise a birefringence material.

The reflective polarizing film 200 reflects the remaining portion of the light supplied from the second polarizer 214 on an interface between the reflective polarizing film 200 and the second polarizer 214, so that the polarizing axis of the reflected light is changed. The reflected light having changed polarizing axis is then reflected on another surface opposite to the interface to repeat the transmitting and reflecting processes. Therefore, substantially all the light passes through the second polarizer 214.

The reflective polarizing film 200 is laminated with the second polarizer 214 so as to prevent the breakage of the LCD panel 210, thereby increasing stability of the LCD panel 210.

The direct-illumination type backlight assembly 220 includes a lamp 222 generating a light, a light diffusion plate 224, a brightness enhancement sheet 226, a protection sheet 228 and a reflecting plate 230. The direct-illumination type backlight assembly 220 may include a plurality of lamps 222. The light diffusion plate 224 diffuses the light generated from the lamp 222 so that the diffused light has a uniform luminance. The brightness enhancement sheet 226 is integrally formed with the light diffusion plate 224 so as to condense the diffused light. The protection sheet 228 is disposed on the brightness enhancement sheet 226 so as to prevent the breakage of the LCD panel 210 by the brightness enhancement sheet 226. The reflecting plate 230 is disposed under the lamp 222 so as to reflect the light generated from the lamp 222 toward the light diffusion plate 224.

The brightness enhancement sheet 226 is integrally formed with the light diffusion plate 224 having an adhesive layer 232 between the brightness enhancement sheet 226 and the light diffusion plate 224. The brightness enhancement sheet 226 is disposed on the light diffusion plate 224. The adhesive layer 232 comprises an adhesive material, for example, such as an acryl resin, a polyester resin, etc.

The brightness enhancement sheet 226 is integrally formed with the light diffusion plate 224. The LCD apparatus does not have a separated diffusion sheet, which a conventional LCD apparatus has, but instead the LCD apparatus of the exemplary embodiment of the present invention has the integrally formed light diffusion plate 224. The brightness enhancement sheet 226 is laminated on the light diffusion plate 224 having the adhesive layer 232 between the brightness enhancement sheet 226 and the light diffusion plate 224.

The brightness enhancement sheet 226 laminated on the light diffusion plate 224 has advantageous in preventing the warping of a sheet, for example, the protection sheet 228, the brightness enhancement sheet 226, etc.

Films having polycarbonates are adhered to the surfaces of a conventional reflective polarizing film to prevent the conventional reflective polarizing film from folding and warping because the reflective polarizing film is thin.

When the polycarbonate films are adhered to the surfaces of the conventional reflective polarizing film disposed on the protecting sheet and the brightness enhancement sheet, the thickness of the reflective polarizing film is increased. The conventional reflective polarizing film having increased thickness presents the protection sheet and the brightness enhancement sheet from folding or warping. The thickness of the conventional reflective polarizing film also increases size and weight of a conventional LCD apparatus.

When the reflective polarizing film 200 is laminated with the second polarizer 214, the brightness enhancement sheet 226 may be warped by the reflective polarizing film 200.

In order to prevent the warping of the bright enhancement sheet 226, the brightness enhancement sheet 226 is laminated with the light diffusion plate 224.

The brightness enhancement sheet 226 is laminated with the light diffusion plate 224 so that the diffusion sheet, which the conventional LCD apparatus has, may be omitted from the LCD apparatus according to the exemplary embodiment of the present invention.

A lamp is disposed on a sidewall of an edge-illumination type backlight assembly so that a light guide plate guiding a light generated from the lamp into an LCD panel and the diffusion sheet diffusing the guided light is necessary to the edge-illumination type backlight assembly.

The lamp 222 of the direct-illumination type backlight assembly is disposed under the LCD panel so that the light guide plate guiding a light into the LCD panel 210 may be omitted, and the direct-illumination type backlight assembly includes the light diffusion plate 224 on the lamp 222.

The light generated from the direct-illumination type backlight assembly has more uniform luminance than the light generated from the edge-illumination type backlight assembly. Therefore, the diffusion sheet that serves as an additional diffusion may be omitted.

The LCD apparatus in accordance with the exemplary embodiment of the present invention is operated as follows.

When the lamp 222 of the direct-illumination type backlight assembly 220 is turned on, substantially all of the light generated from the lamp 222 is incident into the light diffusion plate 224, and the remaining portion of the light generated from the lamp 222 is reflected on the reflecting plate 230 toward the light diffusion plate 224.

The light diffusion plate 224 then changes luminance of the light so as to increase viewing angle.

The changed light from the light diffusion plate 224 is then incident into the brightness enhancement sheet 226 laminated with the light diffusion plate 224 by the adhesive layer 232. A portion of the light incident into the brightness enhancement sheet 226 in a direction different from a direction perpendicular to the light diffusion plate 224 is then refracted into the direction perpendicular to the light diffusion plate 224 so that the light having the direction perpendicular to the light diffusion plate 224 is guided toward the LCD panel 210 through the protection sheet 228.

A portion of the light that is guided toward the LCD panel 210 having a polarization axis substantially the same as the second polarization axis of the second polarizer 214 then passes through the reflective polarizing film 200 laminated with the second polarizer 214. The remaining portion of the light guided toward the LCD panel 210 having a polarization axis different from the second polarization axis of the second polarizer 214 is reflected on the interface between the reflective polarizing film 200 and the second polarizer 214. The reflected light is then reflected again on another surface opposite to the interface so as to repeat the transmitting and reflecting processes. Therefore, substantially all the light passes through the second polarizer 214.

The second polarizer 214 transmits the portion of the light having the polarization axis substantially the same as the second polarization axis of the second polarizer 214. The light from the second polarizer 214 then passes through the liquid crystal layer. The light from the liquid crystal layer is then incident into the first polarizer 212.

Liquid crystal of the liquid crystal layer varies arrangement in response to an electric field applied thereto, and thus an amount of the light supplied to the first polarizer 212 is changed to display an image on the LCD panel 210.

The brightness enhancement sheet 226 includes a prism shape. The ridge that is the upper portion of the brightness enhancement sheet 226 has a round shape having a radius of no more than about 10 μm. Alternatively, the protection sheet 228 may be omitted.

FIG. 2 is a graph illustrating a beam profile of a monitor having an edge-illumination type backlight assembly according to one exemplary embodiment of the present invention. The horizontal axis represents a luminance detected on the light guide plate and the vertical axis represents a viewing angle with respect to a direction perpendicular to the light guide plate.

Referring to FIG. 2, when the edge-illumination type backlight assembly didn't have the diffusion sheet or the brightness enhancement sheet, the edge-illumination type backlight assembly had a low luminance on the light guide plate in the direction perpendicular to the light guide plate as shown in graph ‘a’. When the edge-illumination type backlight assembly included the diffusion sheet, the edge-illumination type backlight assembly had increased luminance in the direction perpendicular to the light guide plate as shown in graph ‘b’. When the edge-illumination type backlight assembly included both of the diffusion sheet and the light diffusion plate disposed on the diffusion sheet, the edge-illumination type backlight assembly had a higher luminance as shown in graph ‘c’ than the increased luminance corresponding to graph ‘b’ in a direction perpendicular to the light guide plate.

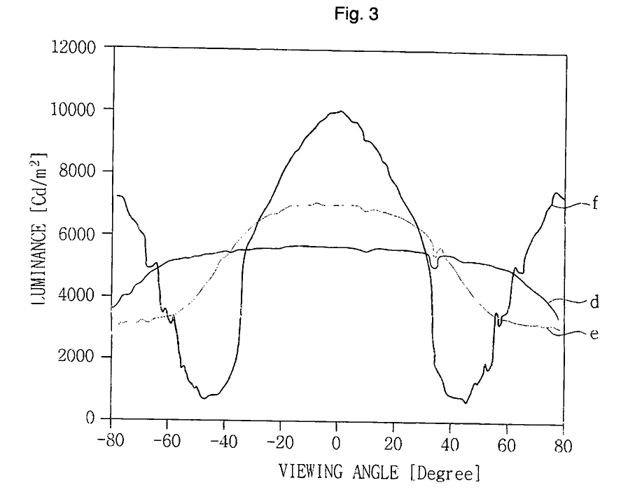

FIG. 3 is a graph illustrating a beam profile of a television receiver set having a direct-illumination type backlight assembly according to one exemplary embodiment of the present invention. The horizontal axis represents a luminance on the light guide plate and the vertical axis represents a viewing angle with respect to a direction perpendicular to the light guide plate.

Referring to FIG. 3, when the direct-illumination type backlight assembly didn't have the diffusion sheet or the brightness enhancement sheet, the direct-illumination type backlight assembly had a low luminance on the light guide plate in the direction perpendicular to the light guide plate as shown in graph ‘d’. When the direct-illumination type backlight assembly included the diffusion sheet, the direct-illumination type backlight assembly had a slightly increased luminance in the direction perpendicular to the light guide plate as shown in graph ‘e’. A difference between the low luminance corresponding to graph ‘d’ and the luminance corresponding to graph ‘e’ of the direct-illumination type backlight assembly was smaller than a difference between the low luminance corresponding to graph ‘a’ and the increased luminance corresponding to graph ‘b’ of the edge-illumination type backlight assembly. The difference between the low luminance corresponding to graph ‘d’ and the slightly increased luminance corresponding to graph ‘e’ of the direct-illumination type backlight assembly was negligible. When the direct-illumination type backlight assembly included the brightness enhancement sheet, and the diffusion sheet is omitted, the direct-illumination type backlight assembly had a higher luminance corresponding to graph ‘f’ in the direction perpendicular to the light guide plate than the low luminance corresponding to graph ‘d’ and the slightly increased luminance corresponding to graph ‘e’.

Therefore, the direct-illumination type backlight assembly generates the light having higher luminance in the vertical direction than a light generated from the edge-illumination type backlight assembly. That is, the direct-illumination type backlight assembly generates a more diffused light on the light guide plate, thereby supplying a light having more uniform luminance without the diffusion sheet.

Hence, the backlight assembly according to the exemplary embodiment of the present invention includes the light diffusion plate 224 laminated with the brightness enhancement sheet 226.

### INDUSTRIAL APPLICABILITY

As described above, the LCD apparatus includes a reflective polarizing film laminated with a lower polarizer disposed under the LCD panel, and a light diffusion plate laminated with the brightness enhancement sheet.

Therefore, the reflective polarizing film is laminated with the LCD panel so as to prevent the breakage of the LCD panel and to increase a stability of the LCD panel.

In addition, the light diffusion plate is laminated with the brightness enhancement sheet so as to prevent the brightness enhancement sheet from folding or warping, thereby increasing the luminance.

Furthermore, the diffusion sheet may be omitted so as to decrease weight and the thickness of the LCD apparatus having the backlight assembly.

This invention has been described above with reference to the aforementioned embodiments. It is evident, however, that many alternative modifications and variations will be apparent to those having skills in the art in light of the foregoing description. Accordingly, the present invention embraces all such alternative modifications and variations as fall within the spirit and scope of the appended claims.

1. A backlight assembly comprising:
a light generating part that generates a light;
a light controlling part that controls the light generated from the light generating part; and
a light condensing part integrally formed with the light controlling part so as to condense the controlled light.

2. The backlight assembly of claim 1, further comprising an adhesive layer disposed between the light controlling part and the light condensing part so as to laminate the light condensing part with the light controlling part.

3. The backlight assembly of claim 2, wherein the adhesive layer comprises an acryl resin or a polyester resin.

4. The backlight assembly of claim 1, wherein the light controlling part comprises a light diffusion plate diffusing the light, and the light condensing part comprises a brightness enhancement sheet that condenses the light.

5. The backlight assembly of claim 4, wherein the brightness enhancement sheet comprises a prism shape including a rounded ridge.

6. An LCD apparatus comprising:
an LCD panel including an upper substrate, a lower substrate and a liquid crystal layer interposed between the upper and lower substrates; and
a backlight assembly including a lamp that generates a light for the LCD panel, a light controlling part that controls the light generated from the lamp, and a light condensing part integrally formed on the light controlling part so as to condense the light.

7. The LCD apparatus of claim 6, further comprising an adhesive layer disposed between the light controlling part and the light condensing part so as to laminate the light condensing part with the light controlling part.

8. The LCD apparatus of claim 6, wherein the LCD panel further comprises a polarizer disposed under the lower substrate to transmit a portion of the light generated from the backlight assembly, and a reflective polarizing film integrally formed under the polarizer to transmit a portion of the light and to reflect a remaining portion of the light.

9. An LCD apparatus comprising:
an LCD panel including an upper polarizer having a first polarizing axis, an upper substrate disposed under the upper polarizer, a lower substrate combined with the upper substrate so as to interpose a liquid crystal layer between the upper and lower substrates, a lower polarizer disposed under the lower substrate to have a second polarizing axis that is substantially perpendicular to the first polarizing axis, and a reflecting polarizing film integrally formed under the lower polarizer; and
a backlight assembly including a lamp that generates a light for the LCD panel, a light diffusion plate diffusing the light generated from the lamp, a brightness enhancement sheet integrally formed with the light diffusion plate so as to condense the diffused light, a protection sheet disposed on the brightness enhancement sheet so as to prevent the breakage of the LCD panel, and a reflecting plate disposed under the lamp so as to reflect the light generated from the lamp into the light diffusion plate.

10. The LCD apparatus of claim 9, further comprising a first adhesive layer disposed between the reflecting polarizing film and the lower polarizer so as to laminate the reflecting polarizing film with the lower polarizer.

11. The LCD apparatus of claim 9, further comprising a second adhesive layer disposed between the brightness enhancement sheet and the light diffusion plate so as to laminate the brightness enhancement sheet with the light diffusion plate.
